(19) United States
(12) Patent Application Publication
(10) Pub. No.: US 2005/0205804 A1
(43) Pub. Date: Sep. 22, 2005

(54) Method for manufacturing light guide plate stamper

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Tu-Cheng City (TW)

(21) Appl. No.: 11/081,955

(22) Filed: Mar. 16, 2005

(30) Foreign Application Priority Data
Mar. 19, 2004 (TW) 93107405

(51) Int. Cl. G21G 5/00

(52) U.S. Cl. 250/492.2; 430/320; 430/321; 250/492.3

(57) ABSTRACT

A preferred method for manufacturing a stamper (15) includes the steps of: providing a stamper substrate (10); converting a desired micro pattern into control signals in a computer; and using the control signals to control a probe (11) to form a corresponding micro pattern of dots on the stamper substrate.

### BACKGROUND OF THE INVENTION

1. Field of the Invention

The present invention generally relates to a method for manufacturing a stamper, and particularly to a method for manufacturing a stamper using to fabricate a light guide plate (LGP) employed in backlight modules.

2. Prior Art

In recent years, implementation of word processoring in compact personal computers has boomed, and portable personal computers known as laptops and notebooks are now in widespread use. In such portable personal computers, a liquid crystal display (LCD) device is commonly used as the display unit.

Conventionally, a backlight module is disposed at a rear side of an LCD screen for lighting the entire LCD screen. To achieve a display with high clarity and resolution, the backlight module providing illumination for the LCD device is required to emit light with high luminance and uniformity. The LGP of the backlight module is key to providing the needed luminance and uniformity. More particularly, the optical performance of a micro pattern of diffusion dots formed on a bottom surface of the LGP is the most important factor influencing the luminance and uniformity characteristics of the LGP.

An LGP with a precise micro pattern can be manufactured by using a stamper configured with a precise “reverse” micro pattern. Thus, the design and manufacturing of LGP stampers has grown rapidly in recent years.

Taiwan Patent No. 503,170 issued on Sep. 21, 2002 discloses a method for producing an injection stamper for use in manufacturing an LGP. The method comprises: producing a patterned soft photo-mask from a soft film; using photolithography to reproduce the patterned soft photo-mask into a non-conductive female stamper; coating a silver film on the non-conductive female stamper; electroplating the non-conductive female stamper to form a stamper core, in which the conductive female stamper can be electroplated directly; stripping off the silver film and the non-conductive female stamper from the stamper core; and putting the stamper core into an electrolyte solution to remove any residual silver film.

However, the above-described method for producing the injection stamper has certain problems. That is, a precision of a reverse micro pattern on the stamper is generally not satisfactory, because the reverse micro pattern is easily damaged when the silver film is stripped off or when the residual silver film is removed. In addition, said method is somewhat complicated, result in much manufacturing time being spent.

### SUMMARY OF THE INVENTION

An object of the present invention is to provide a relatively easy, simple method for manufacturing an LGP stamper with a highly precise micro pattern.

To achieve the above object, a preferred method for manufacturing a stamper in accordance with the present invention comprises the steps of: providing a stamper substrate; converting a desired micro pattern into control signals in a computer; and using the control signals to control a probe to form a corresponding micro pattern of dots on the stamper substrate.

Other objects, advantages, and novel features of the present invention will become more apparent from the following detailed description when taken in conjunction with the accompanying drawings.

### BRIEF DESCRIPTION OF THE DRAWINGS

FIG. 1 is a flow chart of a method for manufacturing a stamper in accordance with the present invention.

FIG. 2 is a schematic, isometric view of a worktable and a probe used in a first embodiment of the method of FIG. 1, also showing a stamper substrate loaded on the worktable.

FIGS. 3 and 4 are enlarged, schematic side views of sequential stages in manufacturing the stamper according to the method of FIG. 2.

FIG. 5 is an enlarged, side cross-sectional view of part of the stamper manufactured according to the method of FIG. 2.

FIG. 6 is an enlarged, schematic side view of a probe and an electromagnetic convergent apparatus used in a second embodiment of the method of FIG. 1, also showing a stamper substrate under the electromagnetic convergent apparatus.

FIG. 7 is an enlarged, side cross-sectional view of part of a stamper manufactured according to the method of FIG. 6.

### DETAILED DESCRIPTION OF THE INVENTION

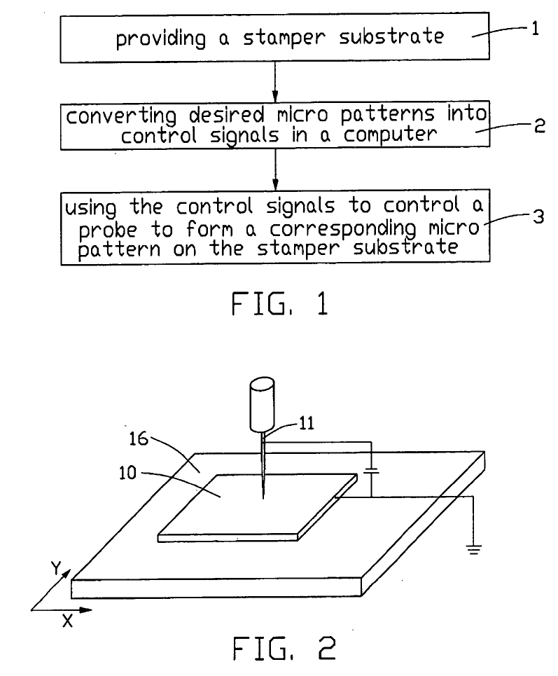

The first embodiment of the method for manufacturing an LGP stamper having a highly precise micro pattern according to the present invention will be described with reference to the flowchart of FIG. 1. The method comprises the steps of:

(1) Providing a stamper substrate. As shown in FIG. 2, a stamper substrate 10 with a flat surface is disposed on a precision worktable 16, and is connected to ground. The stamper substrate 10 is rectangular, and is made of silicon or a metallic material.

(2) Converting a desired micro pattern into control signals in a computer. The desired micro pattern is generated in a computer using appropriate software, and corresponds to a pattern of dot protrusions (hereinafter, “dots”) of a finished stamper. The desired micro pattern is then converted into control signals.

A motor (not shown) is connected to the computer and the precision worktable 16. The control signals generated by the computer control the motor to move the precision worktable 16 along two perpendicular axes X and Y, as shown in FIG. 2.

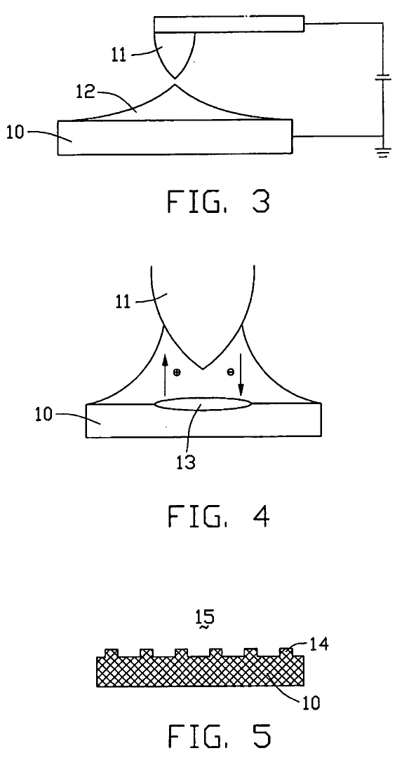

(3) Using the control signals to control a probe 11 to form a corresponding micro pattern on the stamper substrate 10 (see FIGS. 2 to 4). Firstly, the probe 11 is mounted above the stamper substrate 10 on a cantilever controlled by the computer. The probe 11 is made of nanoscale material such as carbon nanotubes, and has a tip with a diameter of 20-30 nm.

Secondly, the probe 11 is controlled to move near the surface of the stamper substrate 10. Simultaneously, the stamper substrate 10 can move back and forth along the X axis as well as along the Y axis, under the control of the computer. The control signal generated by the computer according to the desired micro pattern applies negative voltage on the probe 11 when the tip of the probe 11 is opposite to a certain position of the surface of the stamper substrate 10 where a dot is to be formed.

The environmental temperature is controlled at about 10-40 degrees Centigrade, and the relative humidity is controlled at about 30-80%. A water layer 12 is formed on the surface of the stamper substrate 10. When the probe 11 tip with negative voltage comes near the water layer 12, the electric field. (not shown) formed between the probe 11 tip and the stamper substrate 10 ionizes water molecules in the water layer 12. The OH⁻ and O²⁻ ions ionized from the water molecules react with the Si atoms on the surface of the stamper substrate 10, thereby generating and SiO₂ 13 on the stamper substrate 10. A region of the reaction is controlled by moving the probe 11 and/or the stamper substrate 10 precisely. As a result, a certain number of layers of SiO₂ 13 are stacked together to form a dot 14 (see FIG. 5). The size and shape of the dot 14 can be determined by controlling the reaction region and the reaction period. In the case where the stamper substrate 10 is formed of metallic material, metal oxide is formed on the stamper substrate 10 instead of SiO₂ 13.

Thirdly, the previous step is repeated. In each repeat, the probe 11 and/or the stamper substrate 10 are moved, and the application of negative voltage on the probe 11 is controlled to form another corresponding dot 14 on the surface of the stamper substrate 10. Eventually, a stamper 15 with the desired micro pattern of dots 14 is obtained, as indicated in FIG. 5.

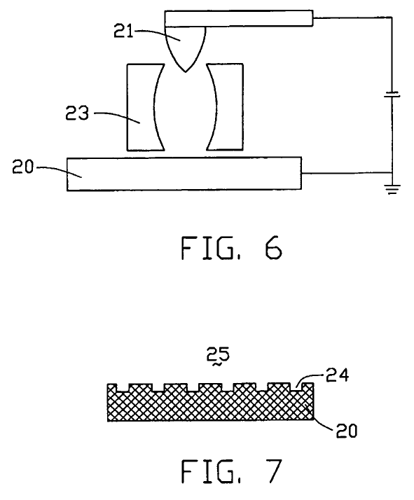

Referring to FIGS. 6 and 7, the second embodiment of the method for manufacturing an LGP stamper having a highly precise micro pattern according to the present invention is generally similar to the first embodiment, except for the ambient conditions and the apparatus used.

Regarding the ambient conditions, the environmental temperature is kept at about 100-120 degrees Centigrade for about 4-6 hours before proceeding, and a reaction chamber is evacuated or filled with one or more inert gases. Regarding the apparatus, an electromagnetic convergent apparatus 23 is provided between a probe 21 and a surface of a stamper substrate 20.

In operation, when a tip of the probe 21 with negative voltage comes near a certain position over the surface of the stamper substrate 20, electric current (not shown) is generated between the tip of the probe 21 and the stamper substrate 20 because of the vacuum or inert gas environment. Electrons (not shown) accelerated by the electric field flow from the probe 21 tip into the electromagnetic convergent apparatus 23, which converges the electrons into a narrow stream. The electrons bombard the surface of the stamper substrate 20 and form a recess 24 (see FIG. 7) therein. The size and shape of the recess 24 can be determined by controlling the reaction region and the reaction period. The operation described above is repeated numerous times, thereby yielding a stamper 25 with a desired micro pattern of recesses 24.

Further, instead of a single probe 11, 21, an arrangement or array of two or more probes, may be used. For example, 1,000 or more probes 11, 21 may be deployed.

The stamper 15, 25 manufactured by the method of the present invention has a higher precision than that of the prior art. The precision can reach nanoscale proportions, with the dots 14, 24 having diameters in the range from 50-100 mn. Further, the method of the present invention provides is less complicated than that of the prior art.

It is to be understood that the invention may be embodied in other forms without departing from the spirit thereof. Thus, the present examples and embodiments are to be considered in all respects as illustrative and not restrictive, and the invention is not to be limited to the details given herein.

1. A method for manufacturing a light guide plate stamper, comprising the steps of:
providing a stamper substrate;
converting a desired micro pattern into control signals in a computer; and
using the control signals to control a probe to form the corresponding micro pattern on the stamper substrate.

2. The method for manufacturing a light guide plate stamper as claimed in claim 1, wherein the environmental temperature is controlled at about 10-40 degrees Centrigrade, and the relative humidity is controlled at about 30-80%.

3. The method for manufacturing a light guide plate stamper as claimed in claim 2, wherein the third step further comprises the steps of:
applying a negative voltage on the probe when a tip of the probe is opposite to a point on a surface of the stamper substrate where a dot is to be formed; and
repeating the previous step a desired number of times by moving the probe and/or the stamper substrate and controlling the application of a negative voltage to form a desired pattern of dots on the surface of the stamper substrate.

4. The method for manufacturing a light guide plate stamper as claimed in claim 3, further comprising the following step before applying a negative voltage:
moving the probe and/or the stamper substrate precisely under the control of one or more of the control signals.

5. The method for manufacturing a light guide plate stamper as claimed in claim 1, wherein the environmental temperature is kept at about 100-120 degrees Centigrade, and the reaction chamber is in vacuum.

6. The method for manufacturing a light guide plate stamper as claimed in claim 1, wherein the environmental temperature is kept at about 100-120 degrees Centigrade, and the reaction chamber is filled with one or more inert gases.

7. The method for manufacturing a light guide plate stamper as claimed in claim 5, wherein the third step further comprises the steps of:
applying a negative voltage on the probe when a tip of the probe is opposite to a certain position of a surface of the stamper substrate where a dot is to be formed;
converging electrons emitted from the probe by an electromagnetic convergent apparatus to bombard a spot on the surface of the stamper substrate; and
repeating the above-described steps a desired number of times to form a desired pattern of dots on the surface of the stamper substrate

8. The method for manufacturing a light guide plate stamper as claimed in claim 7, further comprising the following step before applying a negative voltage:
moving the probe and/or the stamper substrate precisely under the control of one or more of the control signals.

9. The method for manufacturing a light guide plate stamper as claimed in claim 1, wherein the stamper substrate comprises silicon.

10. The method for manufacturing a light guide plate stamper as claimed in claim 1, wherein the stamper substrate comprises metallic material.

11. The method for manufacturing a light guide plate stamper as claimed in claim 1, wherein the probe is made of a nanoscale material.

12. The method for manufacturing a light guide plate stamper as claimed in claim 11, wherein the nanoscale material comprises carbon nanotubes.

13. The method for manufacturing a light guide plate stamper as claimed in claim 12, wherein the tip of the probe has a diameter of 20-30 nm.

14. The method for manufacturing a light guide plate stamper as claimed in claim 1, wherein the third step comprises using the control signals to control a plurality of probes to form the corresponding micro pattern on the stamper substrate.

15. A method for manufacturing a stamper with a micro pattern, comprising the steps of:
digitizing said micro pattern to generate related control signals;
providing an electrifiable nanoscale probe;
preparing a substrate predetermined to be made as said stamper and facing said nanoscale probe;
controlling relative movement between said nanoscale probe and said substrate based on said control signals; and
electrifying said nanoscale probe to create said micro pattern orderly on said substrate corresponding to said relative movement so as to form said stamper.

16. The method as claimed in claim 15, wherein said nanoscale probe is made of carbon nanotubes.

17. A method for manufacturing a stamper with a micro pattern, comprising the steps of:
computerizing said micro pattern to generate related control signals;
providing an electrifiable probe with a nano-scale tip;
preparing a substrate facing said tip of said probe;
moving one of said probe and said substrate via said control signals; and
electrifying said probe to create said micro pattern on said substrate corresponding to movement of said one of said probe and said substrate so as to form said stamper.

18. The method as claimed in claim 17, wherein said substrate is movable back and forth along a preset X axis and a preset Y axis with respect to said probe.
